(19) United States
(12) Patent Application Publication
(10) Pub. No.: US 2011/0295457 A1
(43) Pub. Date: Dec. 1, 2011

(54) SYSTEM FOR CONTROLLING A VEHICLE WITH DETERMINATION OF ITS INSTANTANEOUS SPEED RELATIVE TO THE GROUND

(75) Inventors: Jean-Louis Linda, La Tour-De-Treme (CH); Daniel Walser, Villars-Sur-Glane (CH)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 12/739,894

(22) PCT Filed: Nov. 10, 2008
(86) PCT No.: PCT/EP2008/065215

§ 371 Date: Jun. 28, 2010

(30) Foreign Application Priority Data
Nov. 9, 2007 (FR) 0758948

(51) Int. Cl. G06F 7/00

(52) U.S. Cl. 701/29

(57) ABSTRACT

A vehicle control system is described which comprises a determination of the instantaneous ground speed of a vehicle having at least two wheels, each equipped with a sensor (11) designed to supply a measurement that is a function of the movement of said wheel. It comprises a module indicating the circumferential speed (Vᵣ) of each of these wheels from the corresponding sensor, a first vehicle speed indicator producing an overall speed estimation of the vehicle relative to the ground as a function of the indication from the module for at least one wheel, an acceleration sensor on board the vehicle (285) supplying a measurement that is a function of at least one longitudinal acceleration component of the vehicle (γₘₑₛ), and a second vehicle speed indicator able to produce an estimation of the overall speed of the vehicle relative to the ground by integration of an acceleration indication derived from the acceleration sensor when the estimation resulting from the first indicator is not valid. The system also comprises a diagnostic stage suitable for testing the reliability of each of these indications obtained from the module as a function of the condition of the corresponding wheel at a considered instant and an estimator of the acceleration of the movement of the vehicle (γₘᵥₜ) relative to the ground (280) as a function of the measurement from the acceleration sensor and of at least one acceleration measurement (Ωᵣ) obtained from said wheel sensors, to take account in particular of the slope δ_{y} of the ground on which the vehicle is rolling relative to the horizontal.

### FIELD OF THE INVENTION

The present invention relates to land vehicles, in particular road vehicles. It targets in particular the techniques for controlling such vehicles and the determination of their speed relative to the ground for this purpose, in order to adjust the parameters that determine its behaviour and improve running conditions and safety. It is particularly well suited to the case where the movement of the vehicle on the ground is controlled by one or more specific electric machines coupled to a driving wheel to apply to it a driving torque or braking torque according to requirements.

### STATE OF THE ART

Electric vehicle proposals have progressed a great deal in recent years. The patent U.S. Pat. No. 5,418,437 can, for example, be cited which describes a four-wheel vehicle, of series hybrid type, each wheel being driven by an electric machine that is specific to it, a controller making it possible to control the motors incorporated in the wheel and handling the management of the energy supply to the motors from an alternator or from a battery. When the energy supply is interrupted, the movement of the wheel under the action of the inertia of the vehicle can in turn drive the electric machine and enable it to operate as a generator to an electric load by then applying a so-called regenerative braking torque to that wheel.

This patent remains silent on the management of the electric braking that is obtained, but the state of the art does contain examples of such management to complement the conventional friction-based mechanical braking controls. Thus, for example, the patent application published in the United Kingdom under the reference GB 2 344 799 describes a vehicle capable of generating several regenerative braking power levels from electric traction motors, so as to supply a function simulating the braking by compression or engine braking that is normally available with internal combustion engines, in addition to the traditional mechanical braking function.

Generally, it has already been proposed to use the facility offered by an electric machine on board a vehicle to flexibly and accurately control the torque applied to a wheel of a vehicle that is equipped therewith. Such a possibility has, for example, been used with the wheel anti-lock systems. The patent U.S. Pat. No. 6,709,075 describes a vehicle equipped with an electric motor traction system. A braking function deriving from the operation of this motor as a generator can be added to the friction braking torque applied to each wheel as a function of its behaviour as determined from an ABS system (antilock braking system) with which the vehicle is equipped. Arrangements are made to prevent the regenerative braking from interfering with the correct operation of the ABS system for the regulation of the friction braking.

This facility for accurately controlling the torque applied to a wheel is, more generally, well suited to stability control systems, by the modulation of the braking torque alone or together with that of the engine torque. The PCT patent application published under the reference WO 01/76902 describes a vehicle propulsion and braking system in which each wheel likely to be driven by an internal combustion engine is also coupled to an electric machine capable of selectively applying to it an additional engine torque or a braking torque as a function of the controls of a vehicle stability control system that operates in response to a yaw sensor.

Finally, the patent application published in the United Kingdom under the reference GB 2 383 567 also describes a system in which an electric machine is provided to supply a torque to certain wheels of a vehicle provided with an internal combustion engine. The level of this additional torque is modulated as a function of data supplied by a yaw sensor.

Thus, it is well known to use the engine or braking torque supplied by an electric machine to adjust the forces applied to the wheels of a vehicle by an internal combustion engine. It is also known to use the torque produced by such a machine to adapt the friction braking forces applied to the wheels of an electric traction vehicle.

In the preceding two examples, a yaw sensor is used on board the vehicle to determine the torque level to be applied or to be added to certain wheels of the vehicle to obtain the desired behavioural effects. Other parameters can be measured and used for this purpose. The European patent application EP 0 881 114 presents a control system for vehicles with four wheels each coupled to an independent electric motor, capable of applying an engine or braking torque to each of the wheels, whether guiding or not. A conventional disc brake system is also provided and a steering angle sensor makes it possible to know the orientation of the guiding wheels at each instant. Each wheel motor is equipped with a wheel speed sensor. An indication of the speed of the vehicle relative to the ground is obtained by the system's control unit by combining the information obtained from the signals from the wheel sensors. It is indicated (without more detail) that this indication can be specified using information obtained from on board accelerometers and from a satellite navigation system. The system's control unit continually follows the torque level applied to each wheel, the speed and the steering angle of that wheel, and the estimated ground speed of the vehicle. It also calculates the yaw rate and, from all this information, determines the instantaneous slip of each of the wheels. The control unit controls the traction and braking torques as a function of the values of the slip determined for each wheel and in such a way as to optimize the braking, the acceleration and the steering angle in response to the commands from the driver.

In practice, the indication of the ground speed of the vehicle is a datum that is essential to a control system as proposed in this document. There is no direct measurement on board the vehicle that on its own makes it possible to have access that is not just easy but above all cost-effective and reliable to this datum that is fundamental to characterizing the behaviour of the vehicle. It must therefore be determined by calculations based on other measurements that are easier to obtain directly. It is known that the instantaneous speed of each wheel is an essentially variable factor, which is affected externally by the ground conditions, both with respect to the evenness of its profile and its surface condition, and internally, by the commands to which the wheel is subjected and that affect both its direction and the torques that are applied to it, and by the dynamic reactions of the vehicle itself that are transmitted to it via the suspension of the vehicle.

Thus, simply combining the measurement signals produced by the individual wheel sensors is insufficient to obtain a valid determination of the speed of the vehicle relative to the ground, which is sufficiently accurate, dynamic and reliable for a real-time assessment of the behaviour of the vehicle and its wheels. Furthermore, to be acceptable in practical terms, a solution must be able to be implemented easily and inexpensively on the vehicle.

Various solutions have already been proposed to try to improve the resolving of this problem. The published French patent application FR 2 871 889 describes, for example, a system that performs a diagnosis of the quality of each instantaneous measurement of the longitudinal speed of a wheel, based on the rotation speed supplied by a sensor attached to that wheel, and computes a longitudinal speed of the vehicle from an average of the longitudinal wheel speeds obtained and weighted by quality indices deriving from the preceding diagnosis. This diagnosis also includes a check that the longitudinal speed of each wheel concerned is within a range of values that ensures that the computation method, which is the subject of the patent, is applicable (speed not below 15 kph and not above 250 kph). This diagnosis also includes a check that the derivative of the rotation speed of each wheel concerned is within a certain range indicating that the wheel is neither immobilized, nor slipping, in order to reject the nonconforming indications. Thus, the method does not apply outside these various ranges. The computation is no longer valid outside these limits for supplying a measurement of the slip proper. In the case of a total absence of any conforming indication at a given instant, the system supplies a vehicle speed value extrapolated from the values determined at the preceding instants. Independently of any discussion regarding the applicability of the proposed method to all situations, the proposed extrapolation technique is unsuited to a monitoring of the behaviour of the vehicle by the system that is continuous, or during transitional phases that can last a few seconds, unlike the case of discontinuous operation, for example in an antilock braking control case, in which the system normally allows for a resumption of road grip involving a new valid measurement of the speed, after a fraction of a second following the detection of a fault.

Another proposal for overcoming the above difficulties is explained by the published French patent application FR 2 894 033, in which the longitudinal speed of the vehicle is calculated by combining estimates of the longitudinal speed of certain selected wheels, obtained from sensors measuring the rotation speed of these wheels. The computation method is adapted to each vehicle driving mode. The longitudinal speed of each wheel is corrected as a function of the possible position of the wheel when turning, then the state of the wheel (immobilized or slipping) is tested as a function of the value of the torque applied to that wheel. A test is then carried out on the consistency between the acceleration value obtained from the longitudinal speed obtained previously and the longitudinal acceleration measurement supplied by an accelerometer on board the vehicle. If the consistency checks out, the computed longitudinal speed is retained. Otherwise, it is a value obtained by integrating the measurement from the accelerometer that is adopted.

In practice, the measurement from the accelerometer is affected by the error due to the component of the terrestrial acceleration according to the possible slope of the ground on which the vehicle is moving. It follows that, on the one hand, the validity tests on the longitudinal speed measurements proposed for the wheels do not appear sufficiently accurate to provide reliable indications concerning the vehicle speed and that, on the other hand, the proposed method for testing the consistency of the accelerations and, in the event of a consistency fault, for determining the speed is affected by errors incompatible with continuous operation during periods that can extend to several seconds, for example in the case of prolonged emergency braking (or pronounced acceleration).

Determining the overall speed of a vehicle relative to the ground therefore remains an essential issue in developing vehicle behaviour control systems. Such is more particularly the case, as has been explained above, for the vehicles that have one or more wheels each coupled to an independent electric machine. Furthermore, this issue is particularly important in the case of an electric vehicle for which not only the traction but also braking are fully and directly derived from the electrical energy. The applicant has recently proposed, for example, in the patent application No. WO 2007/107576 such a vehicle equipped with reliable means for ensuring that in all circumstances there is the capacity to have a regenerative electrical braking torque on each wheel concerned that is sufficient to guarantee the safety of the vehicle, without any added mechanical braking. It is advisable to be able to have such a vehicle benefit from the dynamic and accurate traction and braking torque control possibilities offered by the electric machines for controlling the behaviour of such a vehicle.

### DESCRIPTION OF THE INVENTION

In light of the developments that have already been proposed in the state of the art that has just been described, the present invention aims to propose solutions for determining at each instant a sufficiently accurate, dynamic and reliable estimation of the speed of a vehicle relative to the ground, including in driving phases in which the measurement of the usual vehicle monitoring parameters such as the rotation speed of its wheels do not always supply reliable information for obtaining this speed at each instant. It is particularly well suited for controlling the behaviour of a vehicle that has one or more wheels each controlled by one or more electric machines specific to that wheel.

To this end, the subject of the present invention is a vehicle control system comprising a determination of the instantaneous ground speed of a vehicle having at least two wheels, each equipped with a sensor designed to supply a measurement that is a function of the movement of said wheel. This system comprises:

a) a module suitable for supplying at each instant an indication that is a function of the circumferential speed of each of these wheels from the corresponding sensor,

b) a first vehicle speed indicator suitable for producing an estimation of the overall speed of the vehicle relative to the ground as a function of indications deriving from the module a) for at least one wheel,

c) an acceleration sensor on board the vehicle suitable for supplying a measurement that is a function of at least one longitudinal acceleration component of the vehicle, and

d) a second vehicle speed indicator suitable for producing an estimation of the overall speed of the vehicle relative to the ground, by integration of an indication derived from the measurement from the acceleration sensor c) when the estimation resulting from the first indication is not valid.

The system is notably characterized in that it also comprises:

e) a diagnostic stage suitable for testing the reliability of each of these indications obtained from the module a) as a function of the condition of the corresponding wheel at a considered instant, and

f) an estimator of the acceleration of the movement of the vehicle relative to the ground, as a function of the measurement from the acceleration sensor c) and of at least one acceleration measurement obtained from said wheel sensors, to take account in particular of the slope of the ground on which the vehicle is rolling,

and in that the first vehicle speed indicator is suitable for producing said overall vehicle speed estimation from the indications validated as reliable by the diagnostic stage e) for providing an acceptable approximation of the speed relative to the ground of the vehicle at the position of the corresponding wheel, and the second vehicle speed indicator is suitable for integrating the indications supplied by the movement acceleration estimator f), from a determination of the overall speed at a preceding instant, for producing said estimation of the overall speed of the vehicle relative to the ground when no wheel speed indication is validated as reliable at the output of said diagnostic stage for the instant concerned.

According to a preferred embodiment, the diagnostic stage is suitable for testing the condition of each wheel supplying a circumferential speed indication on the basis of at least two criteria chosen from the following three criteria:

x) the instantaneous angular acceleration of the wheel,
y) the measurement of the instantaneous slip of this wheel, determined from angular speed information deriving from the corresponding sensor and from a first estimate of the overall vehicle speed, and
z) the value of the road grip coefficient of this wheel determined from information that can be accessed on board the vehicle.

Thus, the validity of the speed information obtained from each wheel is diagnosed from several angles to make it possible to decide whether this information can or cannot be taken into account in determining the speed of the vehicle. In the absence of direct information on at least one of the wheels at a given instant, the system uses a determination of the acceleration of the movement of the vehicle relative to the ground to obtain by integration a sufficiently accurate estimation of the speed sought.

To determine the movement acceleration of the vehicle, the system in particular makes an evaluation of the slope of the ground on which the vehicle is rolling. The calculations show in effect that a slope with a 5° angle for example induces an error on the speed obtained by integration that is 7 km/h after 4 seconds. Consequently, even in the case where a choice is made to disregard the more ephemeral errors due to the yaw movements of the vehicle, the slope correction is imperative. In practice, it is the inclination of the axis of the vehicle that is more often than not determined. According to the invention, a first value of the latter is determined by a first calculation from an angular acceleration measurement obtained from at least one wheel sensor and from the measurement obtained from the on board longitudinal acceleration sensor. Furthermore, according to a complementary arrangement, the system preferentially includes a sensor, such as a gyrometer, that is sensitive to the rotation movements of the body shell of the vehicle about an axis y that is transversal relative to the longitudinal forward movement axis of the vehicle on the ground to perform a second calculation of the longitudinal inclination of the vehicle relative to the horizontal, and the estimator f) is operative as a function of these two angle indications to determine the acceleration of the movement of the vehicle relative to the ground.

Finally, the system is advantageously provided with a filtering device comprising in particular:

j) a low-pass digital filter for processing first indications of inclination of the vehicle at the output of the first computation device,

k) a high-pass digital filter for the inclination indications supplied by the second computation device, and

l) a stage for digitally composing the indications from the filtering devices j) and k) to deliver a corrected indication of the inclination of the ground to the estimator f).

To sum up, according to the invention, the system tries to compute a first estimation of the overall speed of the vehicle relative to the ground from the signals obtained from the wheel sensors that are equipped therewith. This determination involves a validity diagnostic step on each of the wheels to test the capacity of each of these signals to supply an approximate speed indication of the vehicle at the location of that wheel. Preferentially, the test is performed according to a range of criteria that essentially target conditions of the wheel that are suitable for indicating that it is revolving normally relative to the ground as a function of the movement of the vehicle or, on the contrary, that an abnormal deviation has appeared between its circumferential speed and that of the vehicle relative to the ground at the position of that wheel. Typically, at least two criteria are used, chosen from the instantaneous angular acceleration of the wheel, the measurement of its instantaneous slip, and the value of the road grip coefficient of that wheel. The wheel speed indications that are tested and found to be invalid on completion of the diagnosis are not retained in determining the overall speed estimation. The overall speed estimation sought is determined, for example, as a function of the average of the wheel indications tested and found to be valid after correction for taking into account the position of each wheel when the vehicle is turning.

If no wheel speed indication is validated by the diagnostic stage, the system then determines the instantaneous movement acceleration of the vehicle as a function on the one hand of a longitudinal acceleration measurement carried out by an on board accelerometer and of the angular acceleration measurements for the wheels derived from the wheel sensors. In the case where the ground on which the vehicle is rolling is not horizontal, the signals obtained from the on board accelerometer supply a longitudinal acceleration indication for the vehicle that is not representative of the actual acceleration of the movement of the vehicle relative to the ground because, beyond a slope angle of just a few degrees, the component parallel to the ground of gravity on the measurement from the accelerometer cannot be disregarded. A correction is necessary, which can be obtained according to the invention from the measurement of the wheel accelerations that are directly linked to the actual movement of the vehicle, preferentially complemented by another correction obtained, for example, from the measurement of a gyrometer supplying the yaw rate of the vehicle. A frequency-oriented filtering processing operation on the corrections made makes it possible to access movement acceleration values that are sufficiently stable and accurate to be able to be integrated by supplying appropriate values of the vehicle speed in the absence of valid signals originating from the wheel sensors.

Compared to the solutions described previously, the system is mainly characterized by its simplicity and its affordable cost of implementation for exceptional performance with respect to dynamics and accuracy. It thus makes it possible to produce, notably in the case of a vehicle whose wheels are equipped with electric machines, a vehicle behaviour control system that is effective even when the parameters that characterize its movement are involved in phases of potential instability which can be prolonged, for example in the case of braking, well beyond the durations usually encountered in the existing systems.

Obviously, systems, usually complex, are already known in the state of the art that make it possible to control components of the behaviour of a vehicle that is rolling as a function of parameters measured on board to increase safety. The British patent application document GB 2409 914 describes a system for controlling the attitude of a vehicle equipped as a minimum with at least one longitudinal acceleration sensor, one lateral acceleration sensor and one yaw rate sensor, in addition to a sensor sensing the vehicle speed relative to the ground. Now, as has been explained previously, this last parameter, although essential, is not easy to access directly and in all circumstances on board the vehicle. In fact, determining said parameter is precisely one object of the present invention. Moreover, the means presented in this document for essentially controlling the instantaneous pitch and roll of the vehicle tend to be like a catalogue of the physical relations that govern the kinematics and the dynamics of a vehicle that is rolling. Indeed, the relations that link the angular wheel accelerations to the longitudinal acceleration measured on board the vehicle are presented to show that it is possible in principle to deduce from these data indications on the angle of inclination of the longitudinal axis of the vehicle. However, no information is provided concerning any possible use of this datum for estimating the overall speed of the vehicle nor is there any concrete teaching suitable for resolving the stated problem.

Similarly, the European patent application document EP 1 832 881 describes a system intended to provide an estimation of the instantaneous acceleration of a vehicle, in particular a motorcycle equipped with an ABS system, from measurements supplied by two on board accelerometers, one of them sensitive to acceleration in the direction of longitudinal displacement of the vehicle and the other sensitive to its vertical acceleration. According to the method, the pitch angle of the vehicle is determined from these two measurements to obtain an estimation of the acceleration of the vehicle in the direction of its displacement, corrected for the pitch effects particularly in the phases of intense acceleration or braking that are reflected in torques tilting the vehicle forward or backward about its centre of gravity that affect the indications from the measurement appliances. According to the proposals of this document, the measurements obtained from the accelerometers are processed by Kalman filterings to eliminate the drifts that affect the measured acceleration signals. The corrected acceleration values are combined to provide, at each instant, an accurate vehicle movement acceleration, stripped of these drifts and pitch effects. When rolling at a stable speed (acceleration within a range of plus or minus 0.2 m/s²), the measurement of the wheel speeds is used to provide an indication of the speed of the vehicle. As soon as the vehicle leaves this stable speed following an acceleration or a deceleration, the system is designed to calculate the vehicle speed from an integration of the acceleration compensated for pitch.

Compared to this state of the art, the invention is characterized on the one hand by the fact that the wheel speed measurements constitute the main basis for monitoring the vehicle speed, essential to control of the vehicle, including in transitional speed phases in which it is detected that the road grip condition of the wheels remains compatible with the measurement accuracy or safety. This is obtained thanks to the use of a range of criteria for assessing the validity of the speed information concerning each wheel. It will be recalled that the use of these criteria is mainly linked to controlling the torque applied to each wheel of the vehicle. In this respect, the individual condition of each wheel remains a priority within the context of the present invention even when the individual diagnostic on each wheel detects that none of them is supplying, at a given moment, any valid measurement for estimating the speed of the vehicle. It is just at that moment that recourse to the integration of vehicle acceleration information duly corrected as a function of the slope of its trajectory occurs. According to the invention, this correction is made first as a function of the information obtained from the wheel sensors and from the measurement from a gyrometer supplying the pitch rate of the vehicle as explained in more detail herein below. To return to the state of the art, the instants during which the acceleration of a vehicle lies between plus or minus 0.2 m/s² are extremely random and potentially fleeting according to the driving conditions encountered. It follows that the readjusting of the vehicle speed relative to the speeds of the wheels can also be random and fleeting and therefore the drifts due to the integration of the acceleration for determining the vehicle speed can become significant.

The subject of the present invention is thus a system for terrestrial vehicles that makes it possible to determine an angular parameter affecting the position in space, or the attitude, of a vehicle moving on the ground, such as the slope of the ground on which the vehicle is rolling or the pitch and/or roll angles of the body shell of the vehicle. Such a measurement makes it possible to improve the knowledge and monitoring of the movements of the vehicle and thus offer a means of acting more effectively on its behaviour.

The invention is particularly well suited to vehicles in which the driving and braking of each driving wheel of the vehicle are fully or totally obtained from one and the same electric machine, specific to that wheel. It is particularly powerful for controlling, when the vehicle is rolling, the torques applied by the electric machines to each of the wheels concerned, in particular to provide real-time control of the instantaneous slip or road grip coefficient thereof.

### BRIEF DESCRIPTION OF THE FIGURES

Other objectives and benefits of the invention will become clearly apparent from the following description of exemplary preferred but nonlimiting embodiments, illustrated by the following figures in which:

FIG. 1a diagrammatically represents a system for controlling the driving and the braking of an electric vehicle with four driving wheels, with on board electric energy production; FIG. 1b is a more detailed diagram of a part of FIG. 1a;

FIG. 2 is a diagram illustrating the variation of the road grip coefficient of a wheel as a function of the slip of that wheel relative to the ground;

FIG. 3 is a block diagram illustrating the operation of a module for measuring slip and regulating current as a function of this measurement according to one aspect of the invention;

FIGS. 4a and 4b are flow diagrams of the operation of another module of the inventive system;

FIGS. 5a and 5b illustrate the explanations regarding the determination of the slope angle of the ground from data measured by the vehicle;

FIG. 6 very schematically illustrates a signal processing stage for correcting slope and acceleration measurements;

FIGS. 7a, 7b and 7c are diagrams of the signals produced in the signal processing stage of FIG. 6.

FIG. 8 specifies the definition of the points of application of the forces acting on the vehicle.

### DESCRIPTION OF ONE OR MORE EXEMPLARY EMBODIMENTS

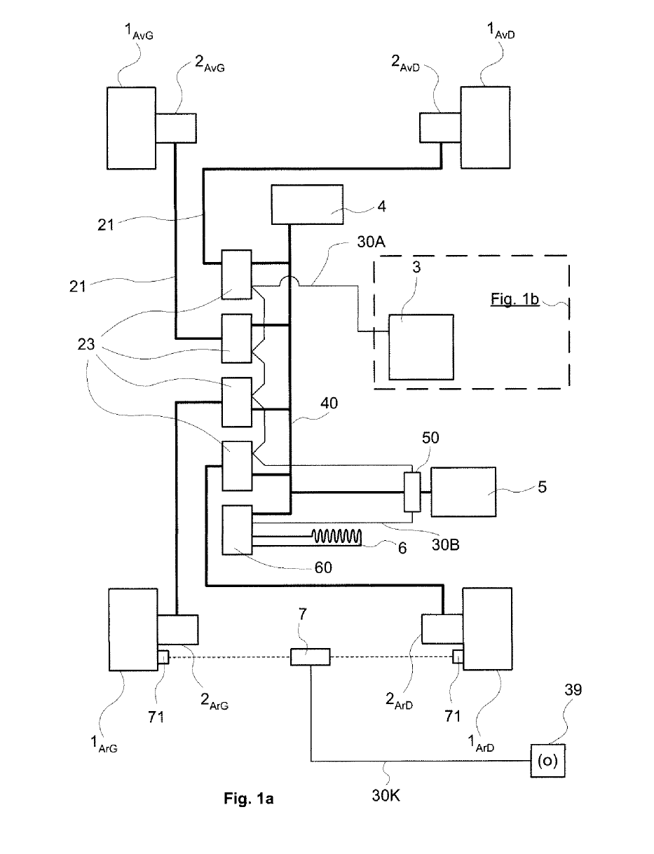

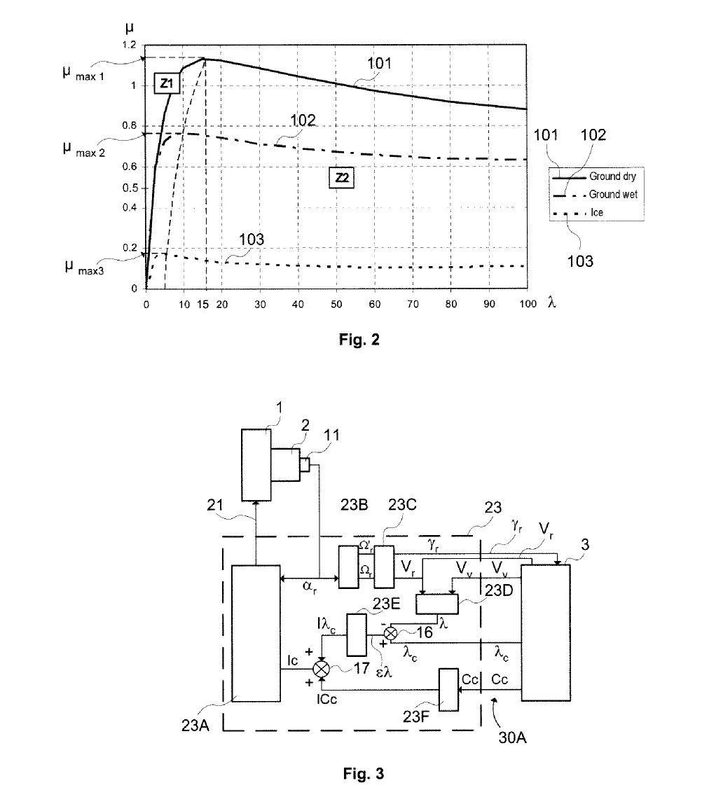

FIG. 1a diagrammatically represents a vehicle with four wheels 1_{AvG}, 1_{AvD}, 1_{ArG} and 1_{ArD}. The wheels are denoted 1_{AvG} for the front left wheel, 1_{AvD} for the front right wheel, 1_{ArG} for the rear left wheel and 1_{ArD} for the rear right wheel. Each wheel is equipped with an electric machine that is mechanically coupled to it. The electric machines 2_{AvG}, 2_{AvD}, 2_{ArG} and 2_{ArD} can be seen. Hereinafter, the indices specifically designating the position of the wheel 1 or of the electric machine 2 in the vehicle will not be repeated when it adds nothing to the clarity of the explanation. The traction electric machines 2 are three-phase machines of self-controlled synchronous type. They are each equipped with an angular position sensor of resolver type 11 (FIG. 3) incorporated behind the machine and are each controlled by a respective electronic wheel control module 23 to which they are connected by electric power lines 21.

The electronic wheel control modules 23 are designed to control the electric machines torque-wise based on the measurement of the currents in the machine and on the measurement from the angular position sensor 11. Each electronic wheel control module 23 makes it possible to selectively impose on the wheel concerned a control torque that is predetermined in amplitude and sign. Because of this, the electric machines can be used as motors and as generators. Each electronic module uses a digital processing function to calculate the rotation speed Ωr of the rotor of the machine and its angular acceleration Ω'r. Knowing the reference development of the wheel, and more precisely its tyre, defined as the linear distance travelled by the vehicle for one wheel revolution in the absence of any torque and longitudinal force, and knowing the reduction of the connecting gearing between the axis of the rotor and the wheel, each electronic module 23 converts the angular speed and acceleration, respectively Ωr and Ω'r, into linear speed and acceleration, respectively, Vᵣ and γᵣ, restored to the vehicle. It should, however, be noted that it would be possible to implement certain principles of the invention with an independent wheel speed measurement, for example, for wheels not equipped with motors, to use a speed sensor of the Hall-effect sensor type for ABS (Anti-Blocking System) or operating on any other principle.

For the record, in this example each of the rear wheels 1_{ArG} and 1_{ArD} is also equipped with a mechanical brake device 71 for the wheel when stopped and only when stopped, controlled by an electric actuator 7 driven by a braking control unit. In the inventive application described here, none of the wheels of the vehicle includes any mechanical service brake. Whatever the amplitude of the braking control signal, that is to say even for the most intense braking situations, the braking is handled solely by piloting the electric machines in generator mode. The means are provided for ensuring the consumption of all the power produced even in a particularly powerful braking situation. These means can comprise a storage capacitance, circuits for using energy produced in real time and means for dissipating the excess power of the preceding two consumption modes. Each wheel includes one or more dedicated electric machines in order to be able to generate a braking force selectively on each wheel, which could not be done with an electric machine that is common to several wheels, for example the wheels of an axle, because in this case there would be a mechanical transmission and a differential between the wheels. The electric machines are dimensioned appropriately to impose on each wheel the highest possible braking force.

In order to make it possible to absorb a high electrical power, dissipating electrical resistors have been installed that are effectively cooled, for example by the circulation of water, the known electric accumulators not being capable of absorbing the electrical power produced by emergency braking or not being capable of absorbing all the electrical energy produced by braking over a long duration, except by installing a capacity such that the weight of the vehicle would be truly prohibitive. Thus, the electric system represented here, a more detailed description of which can be found for example in the patent application WO 2007/107576 A1, published in the name of one of the applicants, is an autonomous electrical system isolated from the environment, with no exchange of electrical energy with the exterior of the vehicle, and therefore also applicable to motor vehicles, application of the electric braking systems being much more difficult than in the case of vehicles connected to an electricity network such as trains or urban trams.

It is possible, for example, to choose to have several electric machines whose torques are added together. In this case, an electronic wheel module can drive several electric machines in parallel installed in one and the same wheel. On the subject of the installation of several electric machines in a wheel, reference should be made, for example, to the patent application WO 2003/065546 and the patent application FR 2 776 966.

The example chosen and illustrated here describes an application to a vehicle that handles the production of electrical energy on board. FIG. 1a shows a fuel cell 4 delivering an electric current to a central electric line 40. Obviously, any other means of supplying electrical energy can be used, such as, for example, batteries. There can also be seen an electrical energy storage device consisting in this example of a bank of supercapacitors 5, linked to the central electric line 40 by an electronic recovery module 50. A dissipating electrical resistor 6 can be seen, preferably dipped in a coolant dissipating the calories to an exchanger (not represented), forming an energy absorption device able to absorb the electrical energy produced by the set of electric machines during a braking situation. The dissipating resistor 6 is connected to the central electric line 40 by an electronic dissipation module 60.

A central computation and control unit 3 manages various functions, including the electric traction system of the vehicle. The central unit 3 dialogues with the set of electronic wheel control modules 23 and with the electronic recovery module 50 via electric lines 30A (CAN bus®). The central unit 3 also dialogues with a plurality of controls detailed in FIG. 1b, namely in particular an acceleration control 33 via an electric line 30E, with a braking control 32 (service brake) via an electric line 30F, and with a control 31 selecting forward or reverse gear via an electric line 30C. The central unit 3 also dialogues, via an electric line 30G, with a measurement sensor or system 35 connected to the steering control 41 of the vehicle and making it possible to determine the steering angle radius Ray. Finally, for the management of the dynamic behaviour of the vehicle in this example, the central unit 3 dialogues, via an electric line 30D, with a sensor 34 sensing acceleration γₓ along the longitudinal axis X of the vehicle, via an electric line 30H, with a sensor or system 36 for measuring the acceleration γ_{y} along a transversal axis Y of the vehicle, via a line 30I, with a sensor 37 sensing the angular yaw rate Ω_{-z} about a vertical axis Z of the vehicle, and finally, via a line 30J, with a sensor 38 sensing the angular speed Ω_{-y} about the transversal axis Y. The information obtained from these sensors enable the central unit 3 to calculate, among other results, the dynamic loads on the wheels as they result from the load deviations between the front and rear wheels and between the right and left wheels of the vehicle as a function of the longitudinal (along the axis X) on the one hand, and transversal (transversal axis Y relative to the movement of the vehicle) accelerations.

The central unit 3 handles the management of the longitudinal displacement of the vehicle, and for this it controls all the electronic wheel control modules 23. It comprises on the one hand a traction operating mode activated by a control signal whose amplitude is representative of the total traction force desired for the vehicle, said control signal coming from the acceleration control 33, and on the other hand a braking operating mode activated by a control signal whose amplitude is representative of the total braking force desired for the vehicle, said control signal coming from the braking control 32. In each of these operating modes, whatever the amplitude of the respective control signal, the central unit 3 controls all the electronic wheel control modules 23 so that the sum of the longitudinal forces originating from the rotating electric machines on all the wheels 1 is a function of said amplitude of the control signal. Such is the case, in particular, for the braking operating mode. In other words, there is no mechanical service brake; the electric braking system described here is the vehicle's service brake.

Moreover, the central unit 3 is programmed to control the application of a specific set point torque to each wheel as a function of the dynamic load of each wheel so as to make each tyre work according to a predetermined behaviour programme. Thus, in the example described here, the programme regulates the torque on each wheel (and therefore the tangential force respectively applied to the ground by each wheel) according to an a priori fixed external strategy. Consequently, as will be seen later, each electronic wheel control module receives from the central unit a torque set point from which it determines a corresponding set point value I_{cc} for the control current of the corresponding electric machine.

To return to FIG. 1a, as indicated previously, the actuator 7 of the mechanical parking brake device 39 is controlled via the electric line 30K only by this parking brake control 39, and absolutely not by the braking control 32 of the service brake, a safety device being provided to prevent the use of this brake outside of the parking situation. Finally, the electronic recovery module 50 dialogues with the electronic dissipation module 60 via an electric line 30B.

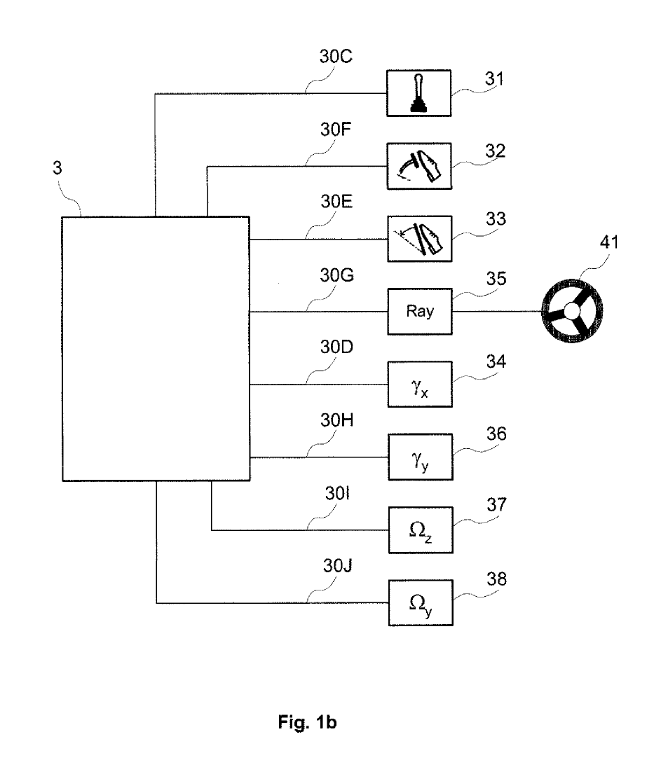

Aspects concerning the implementation of the invention proper will now be explained. FIG. 2 represents three curves showing the variation of the road grip coefficient (μ) of a vehicle wheel 2, which can be typically equipped with a tyre, as a function of the slip (λ) measured in contact with the ground on which the vehicle is rolling, one 101 in the case of dry ground, another 102 in the case of wet, and therefore more slippery, ground and the third 103 in the case of icy and therefore very slippery ground. In these curves, it is possible to distinguish a first shaded area Z1 delimited on the right by a line joining the maximums of the road grip coefficients of these curves. In this area Z1, the operation of the wheel is stable, that is to say that the more the slip increases, the more the road grip coefficient increases also. This makes it possible to transmit to the ground the tangential forces resulting from the engine or braking torque applied to the wheel. In a second area Z2 corresponding to the higher slip values, the operation becomes unstable. As can be clearly seen for the curve 101, when the slip exceeds a certain threshold, in this case approximately 15%, the road grip coefficient drops. The tangential force passed to the ground therefore drops and the excess torque not transmitted further slows down the rotation speed of the wheel which also causes an increase in the slip, and so on; this is the loss of road grip phenomenon that rapidly leads (usually within a few tenths of a second) either to the momentary cancellation of the rotation speed of the wheel by the braking before it is made to rotate in skidding mode in the reverse direction of the displacement of the vehicle, or to its skidding by acceleration in the direction of displacement of the vehicle.

The maximum value of the coefficient (pt) depends on the tyre, the nature of the conditions (dry, wet, etc.) of the ground on which the vehicle is rolling. In the case of a passenger vehicle equipped with tyres with good road grip quality, the optimum value of the road grip coefficient corresponds to a slip rate located about 5% to 15%. Knowing that the road grip coefficient (considered here) is defined by the ratio of the force tangential to the ground to the load perpendicular to the surface of the latter in the area of contact of the wheel with the ground, the values mentioned therefore allow a maximum deceleration of 1.15 g (g here being the acceleration of gravity) on dry ground, 0.75 g on wet ground and 0.18 g on ice, inasmuch as it would be possible to maintain the operating point of the wheel on the ground at this optimum. One of the aims pursued by the present invention is to come as close as possible to this operation through an appropriate control of the torques applied at each instant to at least some of the wheels of the vehicle and, in particular, to the wheels that have driving and braking by electric machine.

FIG. 3 very schematically represents the elements of a device for controlling the traction or braking torque applied to each wheel by the corresponding electric machine 2 as a function of the slip measurements made on that wheel in accordance with the invention. This representation mode is convenient for a good understanding of the explanations that follow. Obviously, the invention can be implemented using programmable hardware devices and conventional software used in managing and controlling road vehicles. The primary role of the electronic wheel module 23 is to control the torque of the motor or motors that are associated with it. The torque-current characteristic of the self-controlled three-phase synchronous machines 2 is well known, so controlling the current in these machines is therefore equivalent to controlling these machines torque-wise. In the wheel control module 23, this basic function is diagrammatically represented by the module 23A which controls the current on the power line 21 from a current set point I_{c} and from an angular position measurement αᵣ of the rotor of the machine 2, delivered by the resolver 11. A computation module 23F makes it possible to convert the torque set point C_{c} delivered by the central unit 3 into the current set point I_{cc} needed to generate this torque. The angular position information αᵣ of the rotor of the machine 2 delivered by the resolver 11 is also used by a module 23B to calculate the angular speed, Ωᵣ, and the angular acceleration, Ω′ᵣ, of said rotor. Knowing the reference development of the wheel, and more precisely of its tyre, defined as the linear distance travelled by the vehicle for a wheel revolution in the absence of any longitudinal torque and force, and knowing the reduction of the connecting gearing between the axis of the rotor and the wheel, the module 23C converts the angular speed, Ωᵣ, and the angular acceleration, Ω′ᵣ, of the rotor respectively into a circumferential linear wheel speed indication, Vᵣ (restored to the vehicle as will be seen later) and into a circumferential linear wheel acceleration indication, γᵣ. These circumferential wheel speed and acceleration indications, respectively Vᵣ and γᵣ, are transmitted to the central unit 3 over the CAN communication bus 30A.

In addition to the torque set point Cc, the control module 23 receives from the central unit 3, via the CAN communication bus 30A, a maximum acceptable slip set point (λ_{c}) and an indication of the ground speed (Vᵥ) of the vehicle proper, to which we will return later.

With a periodicity of 1 ms to 2 ms, the wheel control module 23 performs a calculation of the slip rate X at the instant concerned according to the formula (Vᵣ−Vᵥ)/Vᵥ, diagrammatically represented by a block 23D which receives the digital indications Vᵥ from the central unit 3 and Vᵣ from the module 23C. During a wheel acceleration phase, the wheel speed is greater than the vehicle speed and the slip rate (or slip for short), according to the formula defined previously, is positive, whereas during braking, the wheel speed Vᵣ is less than the vehicle speed Vᵥ and the slip rate is negative. To simplify the explanation, λ will be considered hereinafter to be the absolute value of the slip, in the same way as the maximum slip set point λ_{c} and the current set point I_{cc} will always be considered to be positive. The calculated slip indication is used (as diagrammatically represented by a comparison module 16) to supply a signal indicative of the deviation ε_{λ} between the calculated slip and the set point slip (λ_{c}) delivered by the central unit 3. In the case where the deviation ε_{λ} between the calculated slip λ and the set point slip λ_{c} indicates that this maximum set point is exceeded by the instantaneous slip, this information is used by a regulator 23E, which can, for example, be a conventional PID (Proportional Integral Derivative) regulator, to generate a current set point I_{λc}. An overall current set point I_{c} is then calculated (adder block 17) by summation: (i) of the initial current set point I_{cc}, generated from the torque set point (block 23F), and (ii) of the current set point I_{λc} obtained from the regulator 23E. It is this overall set point I_{c} that is applied to the module 23A controlling the current of the electric machine 2, which also receives the angular position indication for the rotor of the electric machine delivered by the resolver 11. Thus, for example, as long as the slip λ remains less than the set point λ_{c}, during an acceleration phase, nothing happens. If the wheel begins to skid, in which case λ becomes greater than λ_{c}, the deviation from the set point slip becomes negative. The corresponding current indication I_{λc} at the output of the module 23E, also negative, therefore reduces the indication of the initial set point current I_{cc} in the summation block 17 so as to reduce the torque applied to the wheel and keep the slip at the maximum at λ_{c}.)

The information processed by the central unit 3 (torque set point Cc, vehicle speed Vᵥ, and slip set point λc are delivered to the wheel module 23 at a relatively slow rate of 10 to 20 ms, relatively slow but well suited to the vehicle behaviour dynamics. Conversely, the information obtained from the modules specific to each wheel (23B, 23C, etc.) and the processing operations performed by the modules 16, 17, 23D and 23E are performed at a relatively fast rate, corresponding to a period of 1 to 2 milliseconds, well suited to the wheel dynamics. Bearing in mind, finally, that each electronic wheel control module 23 makes it possible to selectively impose on the wheel concerned a control torque that is predetermined in amplitude and sign, there is thus a fast and effective system allowing for ongoing control of the slip in the braking direction (preventing rotation reversal) and in the motive direction (anti-skid), and on each wheel that is fully and solely controlled in traction and braking by the electric machine. A genuine automatic control of the road grip of the wheel with its tyre is produced in this way.

According to another aspect of the invention, the system is arranged to make it possible to determine a value that is overall representative of the ground speed of the vehicle using instantaneous measurements obtained on board and possibly correct this value to obtain the ground speed of the vehicle at the place of each wheel in order for the corresponding slip calculation to remain as accurate as possible in all circumstances, and in particular when turning.

Some aspects of this technique rely on the determination of the road grip coefficient of a given wheel at an instant concerned which must be explained first. When the wheel is subject to just the torque supplied by the electric machine or machines with which it is coupled (either because it does not comprise any internal combustion engine drive, or mechanical braking, typically friction-based—in accordance with the teachings of the patent application filed by the applicant and reviewed in the preamble—or because it is temporarily in this condition at the instant concerned), this torque on the wheel directly corresponds with the current passing through said electric machine or machines 2. Knowing the reference radius of the wheel 1, it is then possible to deduce therefrom, at each instant, the tangential force exerted on the ground by the wheel.

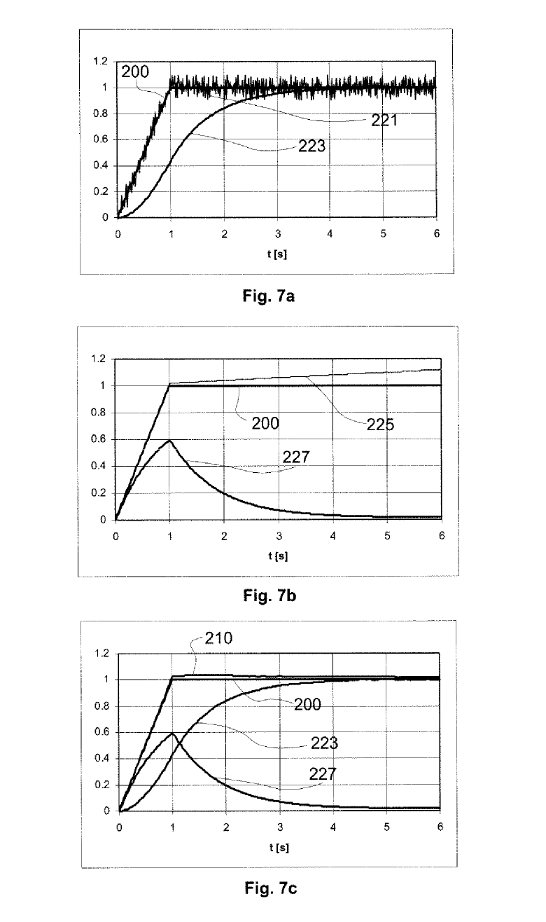

Moreover, knowing the wheel base E of the vehicle (see FIG. 8), the total weight of the vehicle M, its distribution kM and (1−k)M between the rear axle system and the front axle system and the height Hg of the centre of gravity, and finally knowing/measuring the linear accelerations γₓ and γ_{y} supplied by the measurement sensors or systems 34 and 36 (FIG. 1b), the central unit 3 is able to measure, at each instant, the load, or normal force F_{AV} and F_{AR}, on the front and rear axle systems. Knowing the track width V of the vehicle, the central unit 3 is also able to determine the distribution of the loads between the wheels of each of the front and rear axle systems.

The weight and centre of gravity position quantities can be measured when the vehicle is powered up by a suitable system of sensors or any other equivalent. In the example described here, we have more simply opted for nominal values corresponding to the vehicle model concerned with two passengers on board. As indicated previously, the central unit then calculates the instantaneous road grip coefficient μᵣ of the wheel as the ratio between the tangential force and the normal force exerted on the ground by the wheel at the instant concerned.

If we now return to the determination of the vehicle speed, it is based on a calculation of the average of the circumferential speed values of the wheels Vᵣ derived from the measurements of the sensors 11 and previously validated according to criteria that will now be described, to retain only those of these values that are judged reliable for this calculation. Thus, as long as at least one of the wheel speed values is valid, according to these criteria, it will be used to determine the reference vehicle speed at the given instant according to the formula:

Vᵥ=sum of valid Vᵣ/Nb_valid_wheels (g)

If no circumferential wheel speed is valid at the given instant, the vehicle speed is then calculated by the central unit, from the last valid vehicle speed obtained, by integrating an indication of the movement acceleration of the vehicle estimated as will be seen hereinbelow.

The measurement Vᵣ is considered to be valid if the following conditions are met:

(a) The system does not detect any fault in the exchanges of digital information circulating over the CAN bus 30A. The electronic components specifically responsible for managing communication over the CAN bus, and respectively incorporated in the central unit 3 and in each of the electronic wheel modules 23, check the correct operation of the communication system and the integrity of the digital information circulating therein. Said components generate, as appropriate, CAN fault information that can be used by the central unit 3 and/or the electronic wheel modules 23. Moreover, the central unit 3 regularly sends information (set points; Vᵥ; . . . see FIG. 3) to the electronic wheel modules 23 with a rate of between 10 and 20 ms (in this case 16 ms). If this rate is not observed, the electronic module detects a CAN fault (central unit absent following a failure, a break in the CAN connection, etc.) and disregards the data originating from the CAN bus. Symmetrically, the modules 23 respond to the central unit (Vᵣ; current; faults; etc.) with this same rate of 16 ms. If the central unit confirms that the rate is not observed for one of the electronic modules 23, it declares the module concerned to be absent and disregards its data (in particular VA

(b) The electronic control module 23 associated with the wheel concerned does not detect any fault on the resolver 11.

(c) Said wheel has not lost its ground road grip. In this respect, it is considered that there is a loss of road grip mainly when the circumferential wheel acceleration γᵣ is abnormal, that is to say too high for the physics of the vehicle. For example, it is considered that a value exceeding 0.7 g in the motive direction and 1.2 g in the braking direction indicates a loss of wheel road grip. Note that these acceleration values are here derived from the information supplied by the resolver 11 to the wheel control module 23 and to the central unit. When a loss of road grip has been detected on one of the wheels, the return to normal road grip, and therefore to a valid speed measurement for said wheel, occurs only if the slip measurement for the wheel concerned takes a sufficiently low value for it to be possible to consider that the error is acceptable for the vehicle speed measurement (3%), or else that pr is sufficiently low to guarantee the wheel road grip regardless of the ground condition (15% given a very slippery ground condition corresponding to the curve 103 of FIG. 2).

(d) The road grip coefficient (μᵣ) calculated at the instant concerned is less than a limit value (μₗᵢₘ) beyond which the slip, as it results from the curves μ(λ) of FIG. 2, is deemed too high for it to be possible to continue to consider the circumferential speed of the wheel to be an acceptable first approximation of the speed of the vehicle at the place of said wheel. If we consider, for example, a value of (μₗᵢₘ) as represented in the region of 50%, it is possible to confirm that the slip values corresponding to the values of μᵣ below this limit are small (curves 101 and 102). They lead to an error in determining the average speed that does not exceed 1.5 to 3%, which is deemed acceptable.

Observation of the curves of FIG. 2 shows that said curves have little dependency on the ground condition, for values of μᵣ below μ₋ₗᵢₘ (in the region of 50%), when the maximum road grip on the ground μₘₐₓ exceeds μ−ₗᵢₘ (case of μₘₐₓ₁ and μₘₐₓ₂ for the curves 101 and 102). Then, knowing the characteristic μ(λ) of the tyre used, in particular, for μ less than 50%, it would be possible to determine the slip λ corresponding to the working μᵣ at the instant concerned and accordingly weight the wheel speed measurement Vᵣ.

The indication of the road grip coefficient determined as explained can be affected by an error, for example corresponding to the variations of the actual load of the vehicle relative to a nominal load taken into account for calculating the normal force on the wheel. However, it can be confirmed, by observing the curves 101 and 102, that a big error on the road grip coefficient around 50% has little influence on the corresponding slip value. It has been determined in practice that, for the application of the validity criterion described here (namely the validity of the approximation consisting in using the circumferential speed of a wheel instead of the speed of the vehicle measured at the position of the latter) these inaccuracies do not significantly affect the quality of the decision made on the basis of the road grip coefficient value.

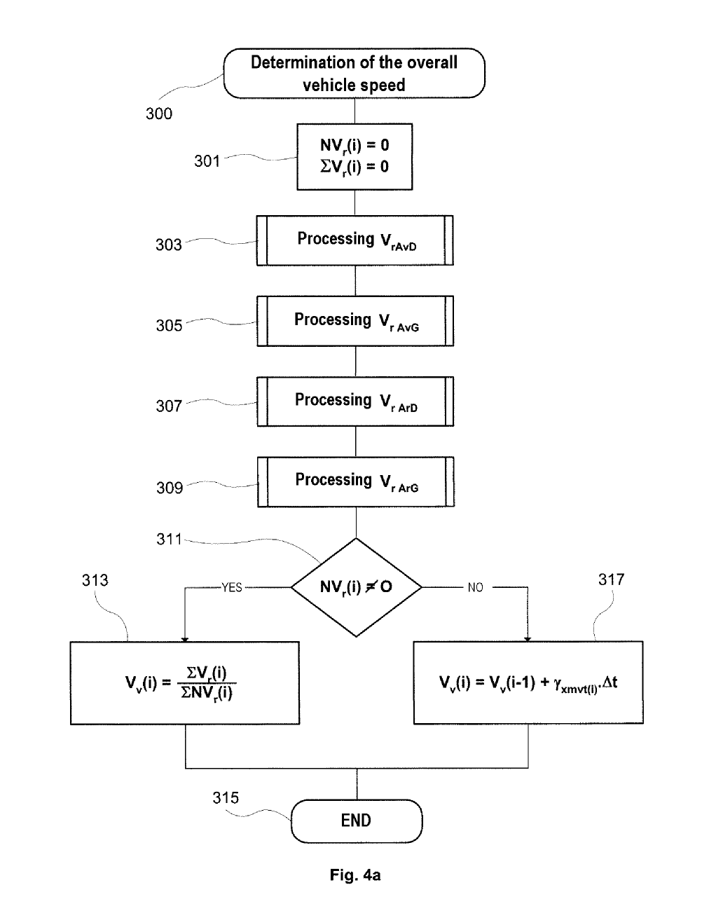

If we now consider the case of ground with a particularly low road grip coefficient (curve 103), the value indicated for exceeds the maximum road grip coefficient μₘₐₓ of the ground. The wheel concerned has a tendency to accelerate very quickly in an abnormal manner but the loss of road grip is then detected by the criterion (c) explained previously. On the other hand, it can be seen that, if the road grip coefficient μ is less than 15%, the wheel is in a situation of road grip with the ground regardless of the state of the latter (curves 101, 102 or 103). This value supplies a test criterion for maintaining or restoring the road grip of the wheel (see step 113 in FIG. 4).

The system thus determines a vehicle speed value that does not strictly represent the speed of a predetermined fixed point of the vehicle (for example, the centre of gravity of the vehicle), and that will be qualified here as “overall”. To calculate the slip of a given wheel, the system must also check that this value is sufficiently close at the moment concerned to the ground speed of the vehicle in the position of the wheel concerned in the trajectory of the vehicle. Such is normally the case if the vehicle is moving in a straight line. In this case, the overall speed Vᵥ transmitted by the central unit to the module 23 makes it possible to directly obtain the appropriate representation of the slip from the wheel speed indication Vᵣ. Such is not the case, on the other hand, when the vehicle is turning. In this case, the overall speed of the vehicle and its speed at the level of the wheel differ by a correction coefficient which is both a function of the turn radius and of the position (inside or outside) of the wheel in the turn. The central unit 3 is programmed to determine this correction coefficient as a function of the indication of the steering angle radius Ray transmitted over the line 30G from the measurement system 35 connected to the steering control 41, and by a factor that takes account of the position (inside or outside) of the wheel in the turn.

The correction coefficients are established according to an empirical relationship for each type of vehicle concerned, in this example on the basis of real measurements carried out on the vehicle concerned. The value of the correction coefficient that is appropriate to each wheel in the instantaneous situation of the vehicle (direction and radius of the turn) is used by the central unit 3 to calculate a corresponding circumferential speed correction value:

ΔVᵣ_{_{Ar}}int,ΔVᵣ_{_{Ar}}ext,ΔVᵣ_{_{Av}}int and ΔVᵣ_{_{Av}}ext,=f(Ray),

(in which Ray here represents the steering angle radius), for the front (_{Av}) and rear (_{Ar}) wheels, inside (int) and outside (ext) in the turn.

The value V, is transmitted to the control module 23 corresponding to each wheel and combined with the circumferential speed of this wheel corrected (Vᵣ+ΔVᵣ) in order to determine the value of the slip at the corresponding instant with sufficient accuracy. It will be noted here that, in the interests of clarity, FIG. 3 does not show the process of transmitting and generating corrected speed values. On the other hand, the principle of this correction is clearly taken into account in the flow diagram of FIG. 4b hereinbelow.

The trials of the applicant have shown that it was possible to determine for each wheel a correction coefficient that gives consistent corrected measurements to within 1.5% for all the wheels concerned.

At this stage, FIGS. 4a and 4b give a simplified flow diagram of the procedure for determining the vehicle speed, for a vehicle with four wheels electrically controlled torque-wise like that of FIG. 1. The flow diagram of FIG. 4b illustrates the processing of the circumferential speed signal V_{rAVD} from the front right wheel 1_{AVD} of the vehicle at a given instant (step 101) and begins with a calculation (step 102) of the value of this speed V_{rc AVD} compensated for any turns by a factor f(Ray, avd) that takes into account both the steering angle radius of the vehicle and the position of the wheel 1_{AVD} relative to the direction of the turn. The system then examines its validity as a first approximation of the vehicle speed at the position or location of this wheel. To this end, the following are checked in succession: the absence of faults on the CAN network (step 103) and in the information from the corresponding resolver 11 (step 105), then, if the result is affirmative, the value of the angular acceleration of said wheel (step 109) relative to an upper limit for entering into a skid and a lower limit corresponding to a deceleration that can lead to a reversal of the direction of rotation of the wheel. If this acceleration value is outside the range defined by these limits, a road grip fault indicator is activated (step 111). Otherwise, the process tests (step 113) whether the last calculated slip value is less than 3% or if the value of the road grip coefficient μ is less than 15% with the result that the wheel has returned to a ground road grip condition after a loss of road grip, even in the case of the curve 103 (ice, FIG. 3). If the test is positive, this leads to the activation of a road grip indicator (step 115). If the result is negative, the process checks the state of the indicators 111 and 115 (step 117) and if a road grip indication has been detected, checks whether the value of the road grip coefficient μ determined for the wheel at that instant is below the upper limit μₗᵢₘ (step 107). If the result of one of the tests 103, 105, 117 or 107 is negative, the process goes directly to the end of the processing operation (point 121) for the wheel 1_{AVD} at the instant concerned and goes on to the next wheel (as explained below with reference to the flow diagram of FIG. 4a). If the test on completion of the step 107 is positive, a counter recording the number of wheels selected on completion of the processing of the wheel signals Vᵣ in the sequence examined for the instant concerned is incremented. The speed of the last wheel selected is added to the sum ΣVᵣ of the speeds of the wheels already selected (step 119).

The processing that has just been reviewed is part of a step 301 of a process for determining the overall vehicle speed (point 300) which begins with an initialization (step 301) of the selected wheel counter and of the selected wheel speed summation register, already mentioned. As also indicated, the signals from the wheels A1 are processed in succession in the processing steps 303 to 309. On completion of this phase, the state of the selected wheel counter is checked (step 311). If this number is not zero, the system calculates the average Vᵥ of the selected wheel speeds (step 313) and displays it as the overall vehicle speed for the instant concerned (point 315) at the end of the process. If the step 311 detects that no wheel has been selected, the output triggers a subprocess (step 317) as will be explained hereinbelow.

Thus, when no circumferential wheel speed measurement taken from the wheel sensors or resolvers 11 can be retained to estimate the ground speed of the vehicle at a given instant, such as, for example, in the case of forceful braking, the central unit 3 calculates the vehicle speed by digital integration of the longitudinal movement acceleration γₓ₋ₘᵥₜ from the overall speed determined for the preceding instant. The vehicle speed at each instant i is then supplied by the formula:

Vᵥ(i)=Vᵥ(i−1)+γₓ₋ₘᵥₜ·Δt, (f)

in which Vv₍ᵢ₎ is the vehicle speed estimated at the instant tᵢ; Vv₍ᵢ₋₁₎ is the vehicle speed estimated at the instant t₍ᵢ₋₁₎; γₓ₋ₘᵥₜ is the movement acceleration of the vehicle and Δt is the time interval between two successive calculations (or 16 ms as indicated for this example).

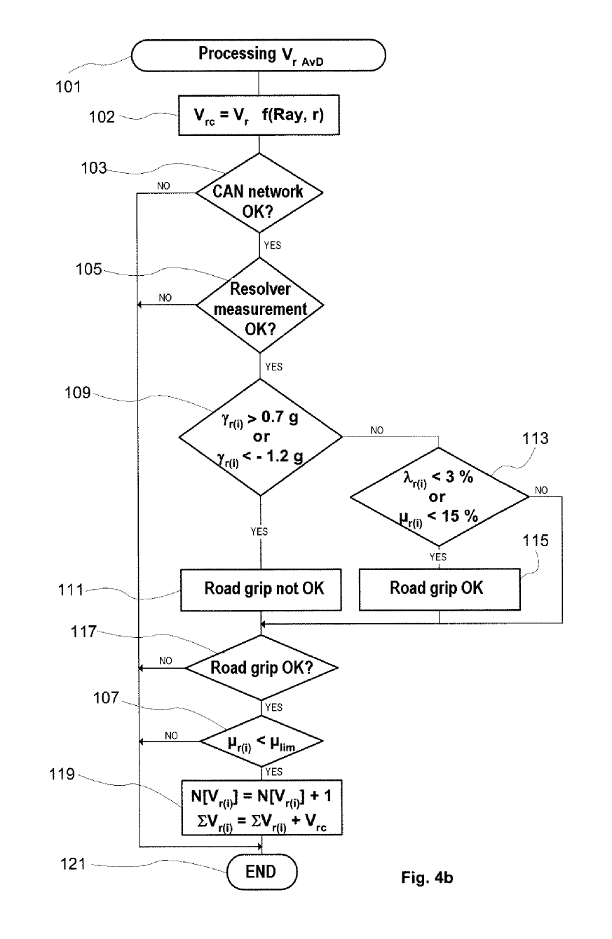

Obviously, it is important to then have a reliable measurement of the vehicle movement acceleration γₓ₋ₘᵥₜ. Conventionally, the accelerometer 34 used in the present example is sensitive to the acceleration γₓ₋ₘₑₛ resulting from the forces applied to the vehicle in the direction and the line of its longitudinal displacement. To simplify the explanations, it is assumed that the axis of the accelerometer 34 is oriented parallel to the ground when the vehicle is stopped and the pitch oscillations of the body shell of the vehicle are disregarded initially. If the ground is horizontal, the measurement γ_{x mes} from the accelerometer 34 truly corresponds to the movement acceleration γₓ₋ₘᵥₜ of the vehicle. On the other hand, when the ground on which the vehicle is rolling 280 is sloped, forming an angle δ with the horizontal (FIG. 5a), the movement acceleration of the vehicle 285 along its displacement axis XX is the resultant of the acceleration γ_{x mes} measured along this axis XX and the component of the acceleration of gravity g along said displacement axis of the vehicle XX (see FIGS. 5a and 5b). The value of this component represents a deviation of g·sin δ between the measured acceleration value γ_{x mes} and the real vehicle movement acceleration value γₓ₋ₘᵥₜ. Thus, for example, a non-compensated slope of 5% induces, on the acceleration measurement, an error of 5% if a braking of 1 g is applied (but 10% if a braking of only 0.5 g is applied) and, on the speed, an error of 7 km/h after 4 s. It is consequently necessary to correct the value γₓ₋ₘᵥₜ to have a vehicle speed measurement that is acceptable for regulating slip according to the relation:

γₓ₋ₘᵥₜ=γ_{x mes}=g·sin δy (a)

The correction is made by the central unit 3 which consequently requires reliable information concerning the value of the angle δ.

The angle δ can be first accessed by using the measurements obtained from the wheel sensors 11. The central unit 3 calculates a first approximation γ_{x wheels} of the movement acceleration of the vehicle from the circumferential acceleration values from each wheel γᵣ which are transmitted to it by the wheel modules 23. The relation (a) hereinabove makes it possible in practice to deduce an estimation of the angle δ according to the formula:

δ_{y-acc}=Arcsin[(γ_{x mes}−γ_{x wheels})/g] (b)

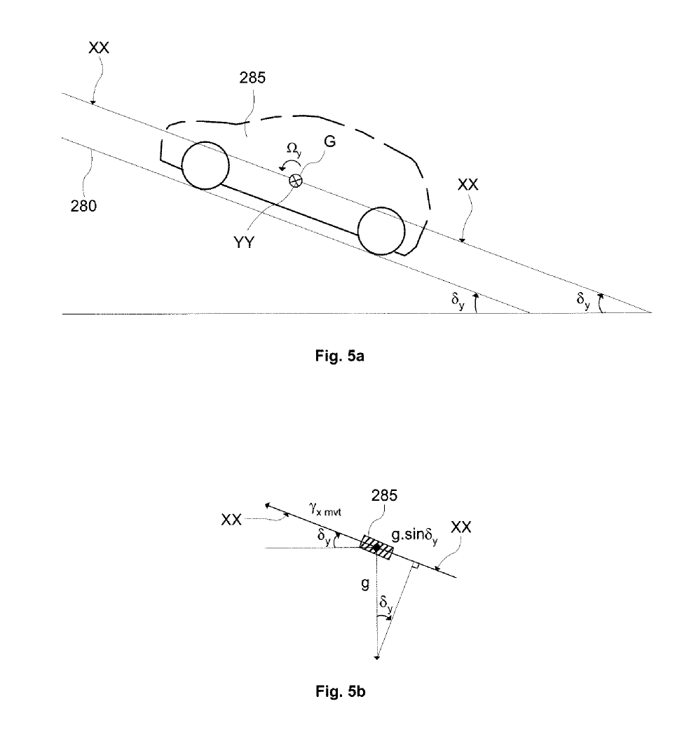

This calculation is the subject of a first stage (F1) of digital processing of the signals illustrated by the block 201 in FIG. 6.

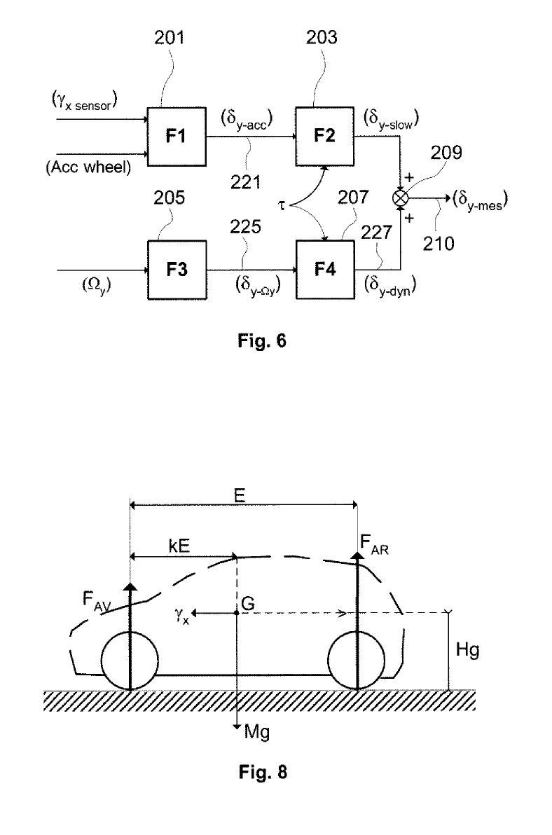

In practice, the signal corresponding to this estimation is very noise-affected. Furthermore, it may be that one of the wheels concerned is in a loss of road grip situation and that the indication γ_{x wheels} used in the calculation of δ_{y-acc} is momentarily disturbed. The processing that follows is illustrated by FIG. 7a which represents (graph 200) a diagram of the curve showing the variation 200 as a function of time of the angle δ_{-real from} 0 to 1 (arbitrary values) in a change of ground slope and the corresponding variation of the estimation 221 (relation (b)) at the output of the stage F1. An additional step to improve the quality of the measurement consists in applying a low-pass digital filtering (stage F2—block 203) of the digital values deriving from F1. FIG. 7a shows the curve of the variation 223 of the signal δ_{y-slow} at the output of F2 which is delayed relative to the variation of the angle but offers good accuracy over the long term.

To obtain an improved indication of the angle δ which is both accurate and sufficiently dynamic, the central unit 3 combines the result with another approximation of the angle δ_{-dyn} deriving from the measurements from the sensor 38 of the angular speed of the vehicle Ω_{y}, about the axis YY parallel to the ground and perpendicular to the axis XX of movement of the vehicle. This signal is integrated over time (stage F3, block 205 FIG. 6) to supply an estimation of the variation of the angle δ (δ_{y-Ωy,}) at the output of F2 represented as 225 in the diagram of FIG. 7b. This signal is well-representative of the angle variation sought over the short term but subject to drift over the long term. It is subjected to a high-pass digital filtering (stage F4—block 207—FIG. 6) with the same time constant as the low-pass filtering applied by the stage F2 to supply the digital indication of which the representation 227 can be seen in FIG. 7b. The outputs of the stages F2 and F4 (FIG. 6) are aggregated in a stage 209 to supply the compensated indication 210 sought for the angle δ (see curve 210 in the diagram of FIG. 7c).

The place of the operations that have just been detailed here in the overall process for determining the overall speed of the vehicle according to the invention is represented by the step 317 in the flow diagram of FIG. 4a. Knowing the angle δ with the desired accuracy, the system calculates the movement acceleration as was explained with respect to the relation (a), then the overall vehicle speed is calculated according to the relation (f). The duly calculated overall vehicle speed for the instant concerned is displayed in the step 315, failing a valid determination that would be obtained directly from the wheel signals.

In fact, the slope angle is the sum of two components, namely the slope δ₁ of the actual ground on which the vehicle is rolling and the angle δ₂ between the displacement axis of the vehicle XX and the ground as a function of the pitch oscillations of the vehicle about an axis YY. In practice, the calculation and the tests show that the variation of this angle has little impact on the accuracy of the corrections required, bearing in mind that, strictly speaking, the correction could be carried out by calculation according to the preceding principles if the circumstances demand it.

In an exemplary embodiment based on the principles that have just been described in detail, with a vehicle with four driving wheels controlled only by electric machines, that is to say in particular without mechanical braking of the movement, average braking decelerations from 80 km/h to zero km/h of the order of 1 to 1.05 g on dry ground have been obtained. In this embodiment, a single slip set point value has been adopted for all wheels, set at 15%. However, implementing the invention does not preclude adopting more sophisticated control schemes in which the slip set point is varied self-adaptively, for example by observing road grip or any other relevant factor having led to the activation of the slip regulator at the instant concerned, to converge as close as possible with the optimum deceleration of the wheel that makes it possible to retain road grip and good behaviour of the vehicle in the particular rolling conditions of the moment.

Obviously, there are, in practice, other methods for accessing certain data that is necessary for correctly using the measurements made. Thus, for example, the use of an inclinometer on board the vehicle could supply additional measurements to increase the reliability of the instantaneous determination of the angle δ.

There are thus also known techniques for determining the vehicle speed based on a very brief interruption of the torque applied to one or more wheels to obtain a value of the vehicle speed directly from the corresponding wheel sensor. The torque on a wheel system (_{Av} or _{Ar} for example) can be reduced periodically for a few fractions of a second to briefly restore the road grip of a wheel on slippery ground and obtain one or more measurements of the speed Vᵣ which are recognized as valid for obtaining a reset value of the overall speed estimation from which, for example, an integration of the movement acceleration can be pursued in the absence of valid signals originating from the wheel sensors.

It is important to stress the point at which the application of the invention is appropriate to a system such as that retained hereinabove by way of example. Such a vehicle is equipped with four driving wheels that are each coupled to a respective rotary electric machine designed and arranged so that the traction and braking are entirely provided from the torques exerted by this machine on the corresponding wheel, with no mechanical braking. This system in fact provides accurate knowledge at all times of the direction and the intensity of these torques and consequently their accurate control as a function of the slip values calculated to optimize the road grip of each wheel independently and in all circumstances.

The invention can also be applied to vehicles that have only one or two wheels (for example at the front) coupled to a rotary electric machine and one or two non-driving wheels. In this case, the driving wheels can benefit from pure electric braking or electric braking in addition to mechanical braking, the brake control pedal then actuating a sensor in the first part of its travel, via the central unit, for purely electric braking on the two front wheels. In the continuation of its travel, the brake pedal acts on a conventional hydraulic circuit to generate additional mechanical braking on the four wheels.

The principle for determining the vehicle speed can be adapted to a speed measurement only on the two wheels equipped with motors (for example at the front). It is also possible to envisage, in this case, as explained above, equipping the rear wheels of the vehicle with only speed sensors in order to also help in generating the indication of vehicle speed relative to the ground. From then on the slip regulator can perfectly well operate on the front wheels in the motive sense (preventing skidding). It can also operate in the braking sense to avoid the cancellation and reversal of the rotation of the wheels in the first part of the travel of the brake pedal where the braking is purely electrical.

Obviously, the invention is not limited to the examples described and represented, and various modifications can be made thereto without departing from its context as defined by the appended claims.

1-5. (canceled)

6. Vehicle control system for determining an instantaneous ground speed of a vehicle that includes at least two wheels, each wheel being equipped with a sensor designed to supply a measurement that is a function of a movement of the wheel, the system comprising:
(a) a module suitable for supplying at each instant an indication that is a function of a circumferential wheel speed of each of the wheels from a corresponding sensor;
(b) an acceleration sensor on board the vehicle suitable for supplying a measurement that is a function of at least one longitudinal acceleration component of the vehicle, and
(c) a vehicle speed indicator suitable for producing speed estimations of the vehicle relative to a ground surface as a function of indications deriving from the module and the sensor for at least one wheel, wherein the vehicle speed indicator includes:
(i) a diagnostic stage suitable for testing at least one road grip condition of the wheels to reject a speed indication deriving from a corresponding module that is not valid to determine a speed of the vehicle relative to the ground surface,
(ii) a test stage suitable for determining if there is at least one wheel for which a speed indication has not been rejected,
(iii) a first module for supplying, in an event of an affirmative response to a test from the test stage, a determination of the speed of the vehicle from a non-rejected indication,
(iv) an estimator that is operative in case of a negative response to a test from the test stage for supplying an estimation of an acceleration of a movement of the vehicle (γₘᵥₜ) relative to the ground surface, as a function of a measurement from the acceleration sensor and of at least one angular acceleration measurement obtained from at least one wheel sensor, and
(v) a second module for integration of a function of the acceleration of the movement produced by the estimator from a determination of a vehicle speed at a preceding instant, to determine the speed of the vehicle relative to the ground surface in an event of a negative response to a test from the test stage.

7. System according to claim 6, wherein the diagnostic stage is suitable for checking a validity of indications obtained from each wheel to supply an appropriate speed indication as a result of a test of at least two road grip criteria chosen from:
an instantaneous angular acceleration of the wheel,
a measurement of an instantaneous slip of the wheel, determined from angular speed information deriving from a corresponding sensor and an estimation of an overall vehicle speed established at a preceding instant, and
a value of a road grip coefficient of the wheel determined from information that is accessible from on board the vehicle.

8. System according to claim 6, wherein the estimator is connected to a first computation device for deriving an indication that is a function of a longitudinal inclination of the vehicle relative to a horizontal orientation from the measurement deriving from the acceleration sensor and from a measurement obtained from a wheel sensor.

9. System according to claim 7, wherein the estimator is connected to a first computation device for deriving an indication that is a function of a longitudinal inclination of the vehicle relative to a horizontal orientation from the measurement deriving from the acceleration sensor and from a measurement obtained from a wheel sensor.

10. System according to claim 8, further comprising a rotation sensor that is sensitive to rotation movements (Ω_{y}) of a body shell of the vehicle about an axis that is transversal relative to a longitudinal forward movement axis of the vehicle on the ground surface associated with a second computation device suitable for deriving therefrom another indication that is a function of the longitudinal inclination of the vehicle relative to the horizontal orientation, wherein the estimator operative as a function of the other indication obtained from the rotation sensor to determine the acceleration of the movement of the vehicle relative to the ground surface.

11. System according to claim 9, further comprising a rotation sensor that is sensitive to rotation movements (Ω_{y}) of a body shell of the vehicle about an axis that is transversal relative to a longitudinal forward movement axis of the vehicle on the ground surface associated with a second computation device suitable for deriving therefrom another indication that is a function of the longitudinal inclination of the vehicle relative to the horizontal orientation, wherein the estimator operative as a function of the other indication obtained from the rotation sensor to determine the acceleration of the movement of the vehicle relative to the ground surface.

12. System according to claim 10, further comprising:
a low-pass digital filter for processing indications of inclination of the vehicle at an output of the first computation device;
a high-pass digital filter for processing indications of a slope supplied by the second computation device at an output of the rotation sensor; and
a stage for digitally composing output indications of the low-pass digital filter and the high-pass digital filter to deliver a corrected indication of the inclination of the ground surface relative to the estimator.

13. System according to claim 11, further comprising:
a low-pass digital filter for processing indications of inclination of the vehicle at an output of the first computation device;
a high-pass digital filter for processing indications of a slope supplied by the second computation device at an output of the rotation sensor; and
a stage for digitally composing output indications of the low-pass digital filter and the high-pass digital filter to deliver a corrected indication of the inclination of the ground surface relative to the estimator.
